(19) United States
(12) Patent Application Publication
(10) Pub. No.: US 2010/0269943 A1
(43) Pub. Date: Oct. 28, 2010

(54) DUCT STRUCTURE OF A HOLLOW WALL USING A THROUGH-PASS DUCT MEMBER

(76) Inventor: Akio Arai, Utsunomiya-shi (JP)

Correspondence Address: Wallace G Walter, 5726 Clarence Ave, Alexandria, VA, 22311, US

(21) Appl. No.: 12/734,806

(22) PCT Filed: Apr. 23, 2009
(86) PCT No.: PCT/JP2009/058786

§ 371 Date: May 25, 2010

(30) Foreign Application Priority Data
May 22, 2008 (JP) 2008 134361

(51) Int. Cl. F16L 11/00; F16L 11/11

(52) U.S. Cl. 138/119; 138/122; 138/109; 52/220.8

(57) ABSTRACT

To provide a through-pass duct member enabling the space in the wall to be more positively shut off against the external space irrespective of the state of the through-pass holes of hollow wall.

A duct member made of synthetic resin having flexibility and resilience wherein, the outer periphery at one side of the duct member 1 is formed with an outer flange 4 at the end side and is integrally provided with an inner flange 5 to form an outer peripheral groove 3 with a groove width approximately equal to a thickness of the inner wall 28 a central side from the outer flange 4; the outer periphery at the other side of the duct member 1 is integrally provided with the inner flange 6 at a location spaced apart from the inner flange 5 at a longer distance than a hollow interval between the walls, and is integrally formed with an insertion guide part at an end side more near than the inner flange 6; the inner peripheral surfaces of the both inner flanges 5 and 6 are formed with inner peripheral grooves 8 and 9 expanding into a thickness of inner flanges 5 and 6; and a bellows-like extension or shrinkage part having a length longer than an interval between an outer wall and an inner wall, having a length stored in the interval between the outer wall and the inner wall when shrunk, and having a thickness deformation flexibility with a force of fingers and recovered is formed between the inner flanges 5 and 6.

### TECHNICAL FIELD

This invention relates to a through-pass duct member installed to keep airtightness within a hollow wall between an outer wall and an inner wall for a through-pass hole opened for arranging a pipe and wirings for facility such as an air conditioner, etc. at the wall such as a hollow wall comprised of the outer wall and the inner wall having a space in a wooden housing, etc., and relates to a duct structure of the hollow wall using the through-pass duct member.

### BACKGROUND ART

Various types of high-airtight wooden housing have been constructed under a guidance of policy for an energy saving countermeasure, for example, that have a hollow wall structure of an outdoor thermal insulation type in which a wall of the wooden housing is made as a double-wall structure having a hollow interval between the outer wall and the inner wall, an airtightness sheet is arranged in tension in at least one inner surface of the wall of the hollow wall and a thermal insulation material is arranged at the outer wall side, and/or a thermal insulation material filled wall structure of indoor thermal insulation type in which the thermal insulation material is arranged at the inner wall side.

In the case that an outdoor unit of the air conditioner, etc. is to be installed in a housing having such a high-airtight wall, it has been usually carried out to perform a piping work for opening the through-pass hole with a diameter of about 65 mm of the outer wall and the inner wall and connecting the indoor unit and the outdoor unit of the air conditioner, etc. In such a case as above, there occurs a possibility that surrounding air or insects, etc. and the like may enter through the through-pass hole into the space in the wall under a state in which the hole is kept open and entering of the surrounding air into the space in the wall may cause a thermal insulation characteristic between the walls to be deteriorated and cause much amount of energy to be consumed uselessly for heating and cooling operations and further entering of insects, etc. and the like into the hole may cause wooden material to be bitten by the insects and damaged, resulting in that a value of the housing is decreased.

Although it has been carried out to fill either synthetic resin putty or mortar in the opening clearance of the through-pass hole from both indoor side and outdoor side in order to prevent surrounding air or insects from entering into such a hollow space, the synthetic resin putty has showed a problem that it causes a shrinkage or elongation or deterioration under an aging variation by ultraviolet rays from outside the housing and either a crack or peeling of the putty is generated, so that it has been hard to keep airtightness between the walls for a long period of time and in turn, in the case of mortar, this has shown a problem that it takes much time to solidify after its filling and it is hard to remove solidified mortar when the device such as the air conditioner is replaced.

In view of the foregoing, there has been proposed to provide a method described in the Patent Document 1 below so as to resolve the problems found in the prior art filling method. That is, the Patent Document 1 provides a method in which no mortar is used, a spiral duct is inserted into the through-pass hole, a resilient seal member is arranged at a clearance between the spiral duct and the wall, and the resilient seal member is held against the wall with a fixing ring threadably engaged with the spiral duct so as to make a complete closing of the clearance. In addition, the present inventor has provided previously a proposal in the Patent Document 2 regarding a wall through-pass duct member which bellows-like of length can be extended or shrunk and its wall structure.
Patent Document 1: Japanese Unexamined Patent Application Publication No. 2000-179750
Patent Document 2: Japanese Patent No. 3848968

### DISCLOSURE OF INVENTION

### Problems to be Resolved by Invention

In the case of the technology described in the aforesaid Patent Document 1, wherein the through-pass hole arranged to prevent the outer appearance in the interior area from being deteriorated by the through-pass hole exposed at the wall surface in the room is arranged while the central positions of the outer wall side and the inner wall side being displaced so as to prevent a strength structure such as a wall stud or a diagonal brace from being damaged, a hard spiral duct cannot be applied.

Even if the spiral duct of the aforesaid Patent Document 1 is used for the through-pass hole of which position is displaced, the spiral duct made of metal such as aluminum or hard material such as engineering plastics, etc. be scarcely bent, its forced bending causes the spiral formed at the spiral duct to be deformed and the fixing ring cannot be threadably engaged with it, so that its practical usage cannot be attained.

In addition, the method described in the Patent Document 1 uses the exclusive spiral duct, the fixing ring threadably engaged with the spiral duct and the resilient seal member, so that this prior art has a problem that its material cost is increased and a quite troublesome working such as threaded engagement between the duct and the fixing ring is required.

Accordingly, in the case that the central positions of both through-pass holes of the outer wall and the inner wall are arranged to be displaced to each other, those skilled in the art could not find out any effective method other than filling both openings with putty or mortar having the aforesaid problems.

In view of the foregoing, in the Patent Document 2 the present inventor proposes the wall through-pass duct member which is bellows-like and its length can be extended or shrunk and a wall structure.

The wall through-pass duct member enabled to prevent airtightness between the walls not damaged and reduced in function of the thermal insulation at the wall, when a case displaced the central positions of both through-pass holes opened at the outer wall and the inner wall which are connect the indoor unit and the outdoor unit such as the air conditioner and the like by the wall through-pass duct member.

In addition, it became possible to perform an easy installation of the duct under a flexibility adaptation against the positional displacements of the through-pass holes at both sides and shut off the space inside the wall against the space outside the wall in such a way that the insects, etc. do not enter into the wall through the through-pass holes, the wall may not be damaged and value of a building may not be deteriorated.

Further, it become possible to perform a positive keeping of airtightness within the hollow wall for a long period of time and fixing work or replacement work for a device such as the air conditioner or the like in an easy manner, by applying the wall through-pass duct member to the hollow wall.

However, there occurred frequently that the state of the through-pass holes opened at the walls is not actually a true circle, but its shape is deformed or decayed, it was hard to perform a complete shut off between the through-pass hole and the wall through-pass duct member under a depressing force applied only with a recovering force of a bellows-like extension or shrinkage part, resulting in that it was also found that airtightness is damaged by the generated clearance.

In view of the foregoing, an object of the present invention is to provide the through-pass duct member enable to the space inside the wall to be more positively shut off the space outside the wall the wall even if irrespective of the state of the through-pass holes, and a duct structure of the hollow wall having superior airtightness using the through-pass duct member.

### Means to Solve Invention

The through-pass duct member integrally formed with a duct member made of synthetic resin having flexibility and resilience that can be passed through and fixed to a through-pass hole of a hollow wall comprised of an inner wall and an outer wall, wherein

the outer periphery at one side of said duct member is formed with an outer flange having a larger diameter than that of said through-pass hole at the end side and is formed with an inner flange having a larger diameter than that of said through-pass hole to form an outer peripheral groove with a groove width approximately equal to a thickness of either said inner wall or the outer wall at a central side from said outer flange;

the outer periphery at the other side of said duct member is provided with an inner flange having a larger diameter than that of said through-pass hole at a location spaced apart from said inner flange at a longer distance than a hollow interval between the walls and is formed with a longer insertion guide part than said hollow interval at an end side more near than said inner flange;

an outer peripheral diameter of said duct member has an outer diameter approximately equal to that of the through-pass hole in the inner wall or the outer wall at the one side at said outer peripheral groove and has an outer diameter approximately equal to that of the through-pass hole at the other side at a location near the inner flange at said insertion guide part side;

the inner peripheral surfaces of said both inner flanges are formed with the inner peripheral grooves expanding into a thickness of the inner flange respectively; and

a bellows-like extension or shrinkage part having an inner diameter approximately equal to that of the through-pass hole, having a length longer than an interval between said the outer wall and the inner wall, having a length stored in said interval between said outer wall and the inner wall when shrunk, and having a thickness with deformable flexibility by finger force and restoring force is formed between said inner flanges.

In the case of the invention described in claim 2, wherein a flexible ring-like filler member having a thickness approximately equal to a groove width of the inner peripheral groove and having resilience is filled in the groove of the inner peripheral groove.

In the case of the invention described in claim 3, wherein the ring-like filler member filled in the groove of the inner peripheral groove is fixed in the inner peripheral groove at its one semi-peripheral side and the other semi-peripheral side not fixed is stored in such a way that it can be taken out of the inner peripheral groove.

In the case of the invention described in claim 4, the through-pass duct member provided with an end part depressing member inserted at the end of the duct member of the through-pass duct member according to any one of claims 1 to 3 so as to fix the end of the duct member in the through-pass hole in the hollow wall, wherein the end part depressing member is provided with a flange part at a base end of a cylinder body having an outer peripheral diameter approximately equal to the inner peripheral diameter of either one or both ends of the duct member, the extremity end of the cylinder body is formed with, at the outer peripheral surface, protrusions that can be engaged in the inner peripheral groove of the duct member under a state where the flange part is connected with the outer surface of the outer wall or the inner wall, and formed with split grooves spaced apart in a peripheral direction of the cylinder body and reaching from the extremity end to the deeper location than that of the protrusions.

In the case of the invention described in claim 5, the through-pass duct member provided with the end part depressing member inserted at the end of the duct member of the through-pass duct member according to any one of claims 1 to 3 so as to fix the end of the duct member in the through-pass hole in the hollow wall, wherein the end part depressing member is made such that the base end of the cylinder body having an outer peripheral diameter approximately equal to an inner peripheral diameter of either one or both of ends of the duct member is formed, at the outer peripheral surface, with a male threaded part and is threadably provided with a flange member formed with a female threaded part threadably engaged with the male threaded part, the extremity end of the cylinder body is formed with, at the outer peripheral surface, with protrusions that can be engaged in the inner peripheral groove of the duct member under a state in which the flange part is connected with the outer surface of the outer wall or the inner wall, and formed with split grooves spaced apart in a peripheral direction of the cylinder body and reached from the extremity end up to the deeper location than that having the protrusions.

In the case of the invention described in claim 6, wherein the flange member of the end part depressing member according to claim 5 comprises a cylinder part and the flange part formed at its extremity end, the inner peripheral surface at the base end side of the flange part is formed with the female threaded part threadably engaged with the male threaded part formed at the outer peripheral surface of the end part depressing member, and the inner peripheral surface at the extremity end side of the flange part is formed with an insertion groove enabling the insertion guide part for the duct member to be inserted.

In the case of the invention described in claim 7, the duct structure of the hollow wall in which the airtightness sheet is arranged in tension at least one inner surface of a wall of the hollow wall comprised of the outer wall and the inner wall, and the through-pass duct member according to any one of claims 1 to 3 is used in respect to the through-pass holes having diameters approximately equal to each other passing through each of these materials, wherein

the through-pass duct member is inserted into the through-pass hole arranged in the outer wall or the inner wall from one of them with the insertion guide part being applied as a leading one;

the outer peripheral groove in the through-pass duct member is fitted and fixed to the insertion side wall, and at the same time the leading inner flange is left in the hollow space of the wall and, the insertion guide part is protruded out of the through-pass hole outwardly;

the both inner flanges depress against the hollow inner wall surfaces of the outer wall and the inner wall with a recovering force of the bellows-like extension or shrinkage part between both inner flanges of the through-pass duct member to shut off between both through-pass holes and the outer periphery of the duct member; and

airtightness of the hollow space between the outer wall and the inner wall can be kept.

In the case of the invention described in claim 8, the duct structure of the hollow wall in which the airtightness sheet is arranged in tension at least one inner surface of a wall of the hollow wall comprised of the outer wall and the inner wall, and the through-pass duct member according to any one of claims 4 to 6 is used in respect to the through-pass holes having diameters approximately equal to each other passing through each of these materials, wherein

the through-pass duct member is inserted into the through-pass hole arranged in the outer wall or the inner wall from one of them with the insertion guide part being applied as a leading one;

the outer peripheral groove in the through-pass duct member is fitted and fixed to the insertion side wall, and at the same time the leading inner flange is left in the hollow space of the wall and, the insertion guide part is protruded out of the through-pass hole outwardly;

the both inner flanges depress against the hollow inner wall surfaces of the outer wall and the inner wall with a recovering force of the bellows-like extension or shrinkage part between both inner flanges of the through-pass duct member to shut off between both through-pass holes and the outer periphery of the duct member;

the end part depressing member according to claim 4 is inserted from the outer flange formed at one side of the through-pass duct member into the duct, and the end of the duct member is fixed to the through-pass hole; and

an air tightness of the hollow space between the outer wall and the inner wall can be kept.

In the case of the invention described in claim 9, the duct structure of the hollow wall using the through-pass duct member according to claim 7 or 8, wherein

the insertion guide part protruded out of the through-pass hole at the insertion guide part side outwardly is cut;

protrusions of the end part depressing member according to any one of claims 4 to 6 are inserted from the cut and removed the insertion guide part side into the inner peripheral groove at the inner peripheral surface of the duct member and engaged with it;

the flange part threadably engaged with the cylinder body of the end part depressing member is rotated and forcedly abutted against an outer surface of the wall;

the wall material is held by the inner flange of the duct member and the flange member of the end part depressing member to fix the end of the insertion guide part side of the duct member to the through-pass hole; and

airtightness of the hollow space between the outer wall and the inner wall at the both sides of the duct member can be kept.

In the case of the invention described in claim 10, the duct structure of the hollow wall according to any one of claims 7 to 9, wherein filler is filled in an opening clearance at the indoor side and the outdoor side in the duct member generated between the wirings and pipes passed and arranged in the duct member installed at the through-pass hole, to shut off between the indoor side and the outdoor side.

### EFFECTS OF INVENTION

The through-pass duct member of the present invention can be easily even if the central positions of both through-pass holes are substantially displaced by inserting the through-pass duct member up to the inner flange into the hollow space through one through-pass hole of either of the inner wall or the outer wall by deforming the duct member in fine shape in such a way that the duct member is pushed with fingers to be depressed because the duct member has flexibility when is installed into the through-pass holes in the inner wall or the outer wall. In this case, since the insertion guide part is longer than the hollow interval between the outer wall and the inner wall and the insertion guide part reaches up to the other through-pass hole, it becomes possible to insert the entire duct member into the hollow space deeply as it is and to install it easily form one direction.

Then, the both inner flanges depress against the hollow inner wall surfaces of the outer wall and the inner wall with a recovering force of the bellows-like extension or shrinkage part between both inner flanges of the through-pass duct member, even if a deformation occurs at the through-pass hole between both through-pass holes and the outer periphery of the duct member, it becomes possible to make a close contact between them in such a way that no clearance may occur and to keep air tightness of the hollow space.

In the state in which the flexible ring-like filler member is filled in the groove of the aforesaid the inner peripheral groove described in claim 2, since the hollow inner wall surfaces of the outer wall and the inner wall are depressed with both inner flanges surfaces with a characteristic cushion of the ring-like filler member, it is possible to make its close contact with the hollow inner wall surface in compliance with the deformation of the through-pass hole even if the through-pass hole shows a substantial deformation, resulting in that it becomes possible to keep higher air tightness of the hollow space.

In addition, in the case of the invention described in claim 3, when both inner flanges are inserted into the through-pass holes, the non-fixed semi-peripheral side of the ring-like filler member filled in the groove of the inner peripheral groove of the ring-like filler member is drawn out of the groove of the inner peripheral groove to cause both inner flanges portions to be bent and deformed easily with their diameters being reduced and additionally, both inner flanges can be recovered smoothly and thereafter work for returning the ring-like filler member into the groove can be easily carried out because one side of the ring-like filler member is fixed in the groove. With this arrangement as above, since the step for inserting the through-pass duct member into the through-pass hole, recovering it and fixing it to the hole can be carried out without any confusion, a working hour for it can be shortened.

In the case of the invention described in claim 4, it becomes possible to insert the through-pass duct member into the through-pass hole from the end part of the duct member and fix the duct member to the through-pass holes of the hollow wall, thereafter the end part of the duct member is engaged with the inner peripheral groove of the duct member at its protrusions with the end part depressing member, the outer flange is depressed with the flange part to enable the through-pass duct member to be rigidly fixed to the through-pass hole.

Further, in the case of the invention described in claim 5, even if the thickness of the wall material in various manner it becomes possible to fix the end part of the duct member to the through-pass hole while freely adapting its thickness by moving a threaded engaging position of the flange part. Due to this fact, if it is installed at the insertion guide part for the duct member, both sides of the duct member hold the wall with the flange part of the end part depressing member and both inner flanges and the through-pass duct member can be fixed more positively to the through-pass hole.

In the case of the invention described in claim 6, the insertion guide part protruded out of the through-pass hole of the duct member at the insertion guide part side can be cut under a state in which it is protruded out of the outer surface of the wall, the protruded part can be held while holding the insertion groove, the flange part of the end part depressing member can be threadably engaged under a close contact state to the outer surface of the wall, the through-pass duct member can be fixed more positively to the through-pass hole and an airtightness between the insertion guide part side can be held more positively.

Further, the inventions described in claims 7 to 9 relate to the duct structure in which the airtightness sheet is applied in tension to the inner surface of at least one of the hollow walls comprised of the outer wall and the inner wall and the through-pass duct member described in one of claims 1 to 3 is used for the through-pass holes of substantial same diameter passed through each of these members.

In the case of the invention described in claim 7, the both inner flanges depress against the hollow inner wall surfaces of the outer wall and the inner wall with a recovering force of the bellows-like extension or shrinkage part between both inner flanges of the through-pass duct member to shut off between both through-pass holes and the outer periphery of the duct member and airtightness of the hollow space between the outer wall and the inner wall is kept.

In the case of the invention described in claim 8, both inner flanges depress against the hollow inner wall surfaces of the outer wall and the inner wall to shut off between both through-pass holes and the duct member and the end part of the duct member can be fixed positively to the through-pass holes with the end part depressing member having the end part of the through-pass duct member engaged with the protrusions in the inner peripheral groove.

In the case of the invention described in claim 9, the insertion guide part protruded out of the through-pass hole at the insertion guide part side is cut and the flange part can be forcedly abutted against the outer surface of the wall with the end part depressing member having protrusions engaged with the inner peripheral groove at the end part of the through-pass duct member, resulting in that a higher airtightness can be attained among the end part of the duct member, the outer wall and the inner wall can be attained.

Under this state, even if the thickness of the wall material at the through-pass hole portions in the wall is substantially different in various manner, it becomes possible to move the position of the flange member threadably engaged with the cylinder body within a range of length of the male threaded part and adjust it freely in compliance with the actual thickness of the wall.

After this operation, in the case of the invention described in claim 10, upon completion of the work such as fixing work or replacement work for a device such as the air conditioner or the like, the clearance between the through-pass duct member and the piping is filled with filler such as putty material and the indoor and the outdoor are completely shut off.

As a method for shutting off between the indoor and the outdoor in this way, the insertion guide portions of the through-pass duct member are not cut but kept as they are, and upon completion of the work such as fixing work or replacement work for a device such as the air conditioner or the like, a method for drawing the insertion guide portions are metered and binding their peripheral portions with either an adhesive tape or a wire and the like is applied, it becomes possible to shut off between the indoor and the outdoor without using any filler at one side.

As described above, the present invention enables the hollow space between the inner wall and the outer wall applied with the airtightness sheet to be shut off against the external space, enables to prevent moisture from being entered into the hollow space, enables to prevent dew from being generated, enables to prevent an effect of thermal insulation of the hollow wall damaged by opening the wall from being reduced, enables a substantial saving of heating or cooling expenditure for use in keeping the indoor temperature constant to be realized and enables a consumption of thermal energy to be restricted and enables it to contribute to keeping of global environment.

### BEST MODE FOR CARRYING OUT INVENTION

This invention relates to the through-pass duct member for the hollow wall and the duct structure of the hollow wall using the through-pass duct member.

As shown in FIG. 6, the through-pass duct member is installed in the through-pass holes 31 and 32 (the through-pass hole for use in passing a water pipe 35 and electrical wirings 36 or a refrigerant pipe connecting the indoor air conditioner 34 and the outdoor unit 33) arranged in the hollow wall comprised of the outer wall 29 and the inner wall 28 having the hollow interval W therein, so that each of the portions constituting the through-pass duct member has a relation with the structure of the wall.

That is, as shown in FIG. 10, the through-pass duct member of the present invention is a duct-like wall surface through-pass member passed and fixed for partitioning the space of the duct for the outdoor unit 33 and the hollow space between the walls in respect to the through-pass holes 31 and 32 where the hollow space having the hollow interval W is formed by the inner wall 28 and the outer wall 29 having the hollow interval W defined by a width of wall stud.

The outer wall 29 is constituted by gypsum board 29c, cement type outer wall 29a and foamed resin thermal insulation material 29b arranged in sequence from inside of the airtightness sheet 30.

Its configuration will be described together with its relation with the hollow wall in detail as follows.

At first, a form of the through-pass duct member will be described.

A basic through-pass duct member of the present invention is made such that, as shown in FIGS. 1(a), 1(b) and 1(c), for example, both sides of the central bellows-like extension or shrinkage part 2 are provided with inner flanges 5 and 6, the outside of one inner flange 5 is formed with the outer flange 4 while holding the outer peripheral groove 3 and the outside of the other inner flange 6 is integrally formed with the insertion guide part 7.

The through-pass duct member is integrally formed with a synthetic resin duct member 1 having flexibility in which the member is started from the state where no force is applied like FIG. 1(a) and a certain force is applied like FIG. 1(b) to show a bent form and the member is finally deformed into a shrunk state of FIG. 1(c), and having resilience for returning back to its original state. Then, this deformed state has such flexibility as one where it can be deformed under depression by a finger and crushed.

As its material, a polyethylene film or rubber-like synthetic resin can be used.

A size of the through-pass duct member is set such that it is restricted by the through-pass holes of the hollow wall comprised of the inner wall 28 and the outer wall 29 fixed as described above.

As shown in FIG. 7, the outer periphery at one side of the duct member 1 is formed with the outer flange 4 having a larger diameter than that of the through-pass hole 31 of the inner wall 28 at the end side, and the at the central side from the outer flange 4 is integrally provided with the inner flange 5 which forms the outer peripheral groove 3 with a groove width approximately equal to a thickness of the inner wall 28.

The outer peripheral groove 3, as shown in FIGS. 1(a), 1(b) and 1(C), for example, a part between the outer flange 4 and the inner flange 5 has a standard plate thickness of 12 mm of a gypsum board in order to adapt for the inner wall 28, and further a width of the outer peripheral groove 3 is 12 mm in such a way that the outer flange 4 and the inner flange 5 can be fitted under an airtight state from both surfaces of the inner wall 28. Further, the inner flange 5 also has a larger diameter than that of the through-pass hole 31.

In addition, the outer periphery of the other side of the duct member 1 is integrally provided with the inner flange 6 having a larger diameter than that of the through-pass hole 32 of the outer wall 29 at a location spaced apart the inner flange 5 at longer distance than the hollow interval W between the walls and is integrally formed with a longer the insertion guide part 7 than the hollow interval at the end part side more near than the inner flange 6.

Further, since the insertion guide part 7 is long, its extremity end may act as a guiding piece and it becomes possible to enable it to be smoothly inserted through the through-pass hole of the inner wall 28 and pulled out of the through-pass hole of the outer wall 29.

Although it is possible for the insertion guide part 7 to fasten the wirings and pipes passed and arranged therein after installation at the wall and to bind the periphery of the wirings and pipes with an adhesive tape etc., in this case, too long insertion guide part may cause the wirings and pipes passed through equipment and arranged there to be hardly passed, so that it is preferable that the binding with the adhesive tape etc. is made as short as possible to a length of allowable range. However, setting its length shorter than the hollow interval W causes the extremity end inserted through the through-pass hole not to reach up to the other through-pass hole, resulting in that it is not preferable because the entire insertion is hardly carried out.

In addition, an outer peripheral diameter of the duct member 1 is formed approximately equal to that of the through-pass hole 31 of the inner wall 28 at the part of the outer peripheral groove 3 formed between the outer flange 4 and the inner flange 5, and the outer peripheral diameter of the insertion guide part 7 is formed approximately equal to that of other side of the through-pass hole 32 of the outer wall 29.

A reason why the outer diameter is formed approximately equal to that of the through-pass holes 31 and 32 consists in a possibility that the smaller diameter than that of the through-pass holes 31 and 32 may generate a clearance between it and the through-pass holes 31 and 32 that corresponds to the difference to cause airtightness of opening edge of the through-pass holes 31 and 32 to be reduced, and in turn, when the outer diameter is larger than that of the through-pass holes 31 and 32, its deformation when the member is installed is not completely recovered and the clearance may occur.

It is usually found that a diameter of the through-pass hole for the air conditioner is set to 65 mm. Accordingly, it is preferable that the outer diameters of the outer flange 4 and the inner flanges 5 and 6 at the through-pass hole at that size are in a range of about 80 mm to 100 mm in consideration of a deformation of the through-pass hole.

Then, each of the inner peripheral surfaces of both inner flanges 5 and 6 are formed with the inner peripheral grooves 8 and 9 that expands into a thickness of the inner flanges 5 and 6.

The ring-like filler member 10 shown in FIG. 5 is made of flexible sponge which having a thickness approximately equal to the groove of the inner peripheral grooves 8 and 9 and having resilience is filled in the groove width of the inner peripheral grooves 8 and 9 as shown in FIG. 2.

Then, the ring-like filler member 10 filled in the groove of the inner peripheral grooves 8 and 9 is fixed in the inner peripheral grooves 8 and 9 at its one semi-peripheral side and the other semi-peripheral side not fixed is stored in such a way that it can be taken out of the inner peripheral grooves 8 and 9.

The ring-like filler member 10 is installed so as to receive, from the inner peripheral grooves 8 and 9, a depressing force got from the inner wall 28 or the outer wall 29 of the inner flanges 5 and 6, and to increase a close fitness between the inner flanges 5 and 6, and the inner surfaces of these walls.

Further, it is also possible to increase an effect of thermal insulation between the hollow space and the external area by covering the surroundings of the through-pass duct member with a thermal insulation material.

The bellows-like extension or shrinkage part 2 is formed between both inner flanges 5 and 6 and in the case that the diameter of the through-pass hole is 65 mm, the inner diameter of the bellows is 65 mm that is approximately equal to that of the through-pass hole and the outer diameter thereof is 80 mm. Then, the bellows-like extension or shrinkage part 2 having a length longer than the hollow interval between the inner wall 28 and the outer wall 29, that having a length stored in the interval hollow interval between the inner wall and the outer wall when shrunk and it having a thickness of about 2 mm that can be deformed flexibility with a force of fingers and also recovered.

Further, the outer flange 4 can be formed into plates of versatile shapes such as a disc plate shape, a semi-circular plate shape or other polygonal plate shapes. Further, in the case that a shape with a glue margin for putty is not applied or filling with putty is not carried out, in consideration of filling with putty, it is also preferable to set either non-noticeable color or non-noticeable shape at the indoor wall surface. In addition, when the through-pass holes hidden at the rear part of the air conditioner which are placed at its outer peripheral part, in the case, a part of the outer flange 4 is exposed out of the through-pass hole, it can be freely machined because its material quality is flexible synthetic resin by applying such a method as one in which the part is cut and removed with scissors or a cutter knife in compliance with a situation of its fixing location.

The through-pass duct member is possible only using the duct member, but as shown in FIG. 3 and FIG. 4, provided with the end part depressing member inserted at the end of the duct member, so as to fix the end part of the duct member in the through-pass hole in the hollow wall.

For example, as shown in FIG. 4(a), the end part depressing member is using harder resilient material than that of the duct member 1, possible to use the end part depressing member 12 is provided with the flange part 14 at one end part of the cylinder body 13 having an outer peripheral diameter approximately equal to an inner peripheral diameter of the end part of the duct member 1.

As shown in FIG. 4(a), the end part depressing member 12 is provided with the flange part 14 at the base end of the cylinder body 13 having an outer peripheral diameter approximately equal to the inner peripheral diameter of either one or both of ends of the duct member 1, the extremity end of the cylinder body 13 is formed with, at the outer peripheral surface, with protrusions 15 that can be engaged in the inner peripheral grooves 8 and 9 of the duct member 1 under a state in which the flange part 14 is connected with the outer surface of the outer wall 29 or the inner wall 28 and formed with split grooves 16 spaced apart in a peripheral direction of the cylinder body 13 and reaching from the extremity end to the deeper location than that of the protrusions 15.

In addition, as shown in FIG. 3, an end part depressing member 17 is made such that a base end of a cylinder body 18 having an outer peripheral diameter approximately equal to an inner peripheral diameter of either one or both of ends of the duct member 1 is formed, at the outer peripheral surface, with the male threaded part 20 and is threadably provided with a flange member 19 formed with the female threaded part 21 threadably engaged with the male threaded part 20, the extremity end of the cylinder body 18 is formed with, at the outer peripheral surface, with protrusions 22 that can be engaged in the inner peripheral grooves 8 and 9 of the duct member 1 under a state in which the flange part 14 is connected with the outer surface of the outer wall 29 or the inner wall 28, and formed with split grooves 23 spaced apart in a peripheral direction of the cylinder body 18 and reached from the extremity end up to the deeper location than that having the protrusions 22.

As the end part depressing member 17, another type of the flange member 19 can be used.

As shown in FIGS. 4(b) and 4(c), it assume the form of comprising a cylinder part 24 and a flange part 25 formed at its extremity end, and the inner peripheral surface at the base end side of the flange part 25 is formed with a female threaded part 26 threadably engaged with the male threaded part 20 formed at the outer peripheral surface of the end part depressing member 17, and the inner peripheral surface at the extremity end side of the flange part 25 is formed with the insertion groove 27 enabling the insertion guide part 7 for the duct member 1 to be inserted.

The protrusions 15 and 22 protruded at the outer periphery of the extremity end of the cylinder body of the end part depressing member 17 can be easily installed at the cylinder body by being curved inward when the protruded portions of the protrusions 15 and 22 pass through the inner peripheral surface of the cylinder body that is narrower than that of the protrusions 15 and 22 with split grooves 16 and 22 cut from the extremity end of the cylinder body more deeper than the positions of the protrusions 15 and 22 and at the same time when it is fitted into the inner peripheral grooves 8 and 9 and hardly pulled out of there and the flange at the end of the through-pass duct member can be positively fixed to the wall.

Next expression, the duct structure in which the airtightness sheet 30 is arranged in tension at least one inner surface of a wall of the hollow wall comprised of the outer wall 29 and the inner wall 28 and the through-pass duct member is used in respect to the through-pass holes having diameters approximately equal to each other passing through each of these materials.

The process work for the duct structure is carried out in such a way that as shown in FIG. 8, the insertion guide part 7 of duct member 1 the being applied as a leading one is inserted from the through-pass hole 31 of the inner wall 28 and further as shown in FIG. 9, the end of the insertion guide part 7 inserted to bridge over the through-pass hole 32 of the outer wall 29 and up to the outer peripheral groove 3 while the duct member 1 is being deformed at the through-pass hole 31 of the inner wall 28.

Although the case shown in FIG. 8 illustrates a method for inserting the duct member 1 from the inner wall 28 and installing it there, it is also possible to bridge the end of the insertion guide part 7 over the through-pass hole 31 from the through-pass hole 32 of the outer wall 29 and insert it while the duct member 1 is being deformed.

Then, as shown in FIG. 9, when it is tried to push into the duct member 1 at the through-pass hole 31 of the inner wall 28, the inner flange 6 at the insertion guide part 7 strikes against the outer wall 29, and further pushing it into the hole causes the length of the bellows-like extension or shrinkage part to be shrunk between inner flanges 5 and 6, the inner flange 5 enters into the hollow space, the outer peripheral groove 3 of the duct member 1 is fitted into the inner wall 28 under its close fitted state, the forward inner flange 6 is left in the hollow space between the walls and the insertion guide part 7 is protruded out of the through-pass hole 32.

Therefore, the both inner flanges 5 and 6 depress against the hollow inner wall surfaces of the outer wall 29 and the inner wall 28 with the recovering force of the bellows-like extension or shrinkage part 2 between both inner flanges 5 and 6 of the through-pass duct member to shut off between both through-pass holes and the outer periphery of the duct member 1 and airtightness of the hollow space between the outer wall and the inner wall is kept.

Then, as shown in FIG. 10 there will be described about a structure, in which, after the part of the insertion guide part 7 protruded out of the outer wall 29 is cut and removed, the end part depressing member is fitted into the end of the duct member 1 to fix the end of the through-pass duct member. As shown in FIG. 11 with reference to this end part depressing member, there occur two cases. One case in which it is fixed to both sides of the end of the duct member 1 and the other case in which it is fixed to only one side of the end of the duct member 1.

In reference to FIG. 11 showing the case in which it is fixed to both side of the end of the duct member 1, there will be described about a duct structure in which the end part depressing member 12 fixed to only one side is applied.

The end part depressing member 12 shown in FIG. 11 is used in the case that a thickness of the wall as found of the inner wall 28 is determined in advance and has a structure in the case that an adjustment in the length of the cylinder body is not required, wherein it is inserted into the duct member 1 from the outer flange 4 formed at the through-pass duct member and the end part of the duct member 1 is fixed to the through-pass hole 31.

The end part depressing member 12 is inserted into the duct member 1 from the outer flange 4 to cause the protrusions 15 of the end part depressing member 12 to be engaged with the inner peripheral groove 8.

This end part depressing member 12 is carried out in such a way that the protrusions 15 at the extremity end of the cylinder body 13 are pushed by the inner peripheral surface of the outer peripheral groove 3 and inserted smoothly through its deformation caused by the split grooves 16, it is recovered at the inner peripheral groove 8, the protrusions 15 are fitted into the inner peripheral groove 8 and hardly pulled out of there and the through-pass duct member is positively fixed to the wall.

That is, the inner wall 28 and the outer flange 4 are held together by the inner flange 5 of the duct member 1 and the flange part 14 of the end part depressing member and fixed at the through-pass hole 31.

In addition, in the case that the thicknesses of the wall material are variously different from each other, the end part depressing member 17 at the outer wall 29 side shown in FIG. 11 can be freely adapted for various thicknesses of the wall material due to motion of the position of the flange member threadably engaged with the cylinder body. After all the insertion guide part 7 protruded out of the through-pass hole 32 of the outer wall 29 at the insertion guide part 7 side of the duct member are cut or removed, the end part depressing member 17 shown in FIG. 3 is inserted into the duct member 1 from the insertion guide part 7 and the end of the insertion guide part 7 is fixed to the through-pass hole 32.

This end part depressing member 17 is inserted into the duct member 1 from the cut and removed insertion guide part 7 side to cause the protrusions 22 of the end part depressing member 17 to be engaged with the inner peripheral groove 9.

This same the case, the installation of this end part depressing member 17 is carried out in such a way that the protrusions 22 at the extremity end of the cylinder body 18 are pushed by the inner peripheral surface of the insertion guide part 7 and inserted smoothly through its deformation caused by the split grooves 23, it is recovered at the inner peripheral groove 9, the protrusions 22 are fitted into the inner peripheral groove 9 and hardly pulled out of there and the through-pass duct member is positively fixed to the wall.

Then, the male threaded part 20 of the cylinder body 18 in the end part depressing member 17 is threadably engaged with the female threaded part 21 at the inner periphery of the flange member 19, the flange member 19 is rotated, forcedly abutted against the outer surface of the wall, the outer wall 29 and the airtightness sheet 30 are held by the inner flange 6 of the duct member 1 and the flange member 19 of the end part depressing member 17 and the end of the insertion guide part 7 of the duct member 1 is positively fixed to the through-pass hole 32.

As described above, in the case of form shown in FIG. 11, airtightness of the hollow space between the outer wall 29 and the inner wall 28 is kept at both sides of the duct member 1 with the end part depressing member 12 of the inner wall 28 and the end part depressing member 17 at the outer wall 29.

Then, the clearances between the duct member 1 and the through-pass holes 31 and 32 at both sides of the duct member 1 are closed through reinforcement of the end part depressing member 17 made of synthetic resin that is harder than the duct member 1 and deformation of the duct member a made of flexible synthetic resin toward to the inner peripheral direction is prevented, so that it may be fixed more positively.

Another form shown in FIG. 12 that is different from the former one showing in such a way that after the insertion guide part 7 protruded out of the through-pass hole 32 at the insertion guide part 7 side of the duct member 1 is cut and removed with a cutter knife, etc. with its part being slightly protruded, the end part depressing member 17 shown in FIG. 4 is inserted into the duct member 1 from the insertion guide part 7, and the end of the insertion guide part 7 side is fixed to the through-pass hole 32.

The end part depressing member 17 is inserted into the duct member 1 from the insertion guide part 7 side and the protrusions 22 of the end part depressing member 17 to be engaged with the inner peripheral groove 9.

This form, the installation of this end part depressing member 17 is carried out in such a way that the protrusions 22 at the extremity end of the cylinder body 18 are pushed by the inner peripheral surface of the insertion guide part 7 and inserted smoothly through its deformation caused by the split grooves 23, it is recovered at the inner peripheral groove 9, the protrusions 22 are fitted into the inner peripheral groove 9 and hardly pulled out of there and the through-pass duct member is positively fixed to the wall.

Then, the flange member 19 shown in FIG. 4 is threadably engaged with the male threaded part 20 of the cylinder body 18 in the end part depressing member 17 through the female threaded part 26, the flange member 19 is rotated and forcedly abutted against the outer surface of the wall.

In this case, the inner peripheral surface of the base end of the flange member 19 is formed with the female threaded part 26 threadably engaged with the male threaded part 20 formed at the outer peripheral surface of the end part depressing member 17, as shown in FIG. 4. The inner peripheral surface of the extremity end of the flange member 19 is formed with the insertion groove 27 enabling the insertion guide part 7 of the duct member 1 to be inserted, the insertion guide part 7 is inserted into the insertion groove 27 to cause the flange member 19 to be threadably engaged to allow itself to be abutted against the outer surface of the outer wall 29.

Then, the outer wall 29 and the airtightness sheet 30 are strongly held with the inner flange 6 of the duct member 1 and the flange member 19 of the end part depressing member 17 and it becomes possible to fix positively the end of the insertion guide part 7 side of the duct member 1 fixing to the through-pass hole 32.

Further, in the case of the duct structure shown in FIGS. 11 and 12, showing the form that a flexible ring-like filler member 10 made of foamed resin is installed in the inner peripheral grooves 8 and 9 of the through-pass duct member.

In the case of this form, the inner flanges 5 and 6 in the hollow space is pushed against the inner surface around the through-pass hole of the wall under a back-up of the ring-like filler member 10 and closely contacted with it, so that a clearance between the through-pass hole and the duct member is positively shut off. That is from the inner peripheral grooves 8 and 9 side, a close fitness among the inner flanges 5 and 6, the inner surface of inner wall 28 and the inner surface of the outer wall 29 is improved under acceptance of pressing force from the inner wall 28 and the outer wall 29 of the inner flanges 5 and 6.

As a result, the indoor space, outdoor space and the hollow space inside the walls are shut off more positively and a reduction in function of the thermal insulation between the walls is prevented and a dew condensation inside the wall is prevented.

Then, as shown in FIG. 13, filler 37 such as a putty and the like is filled in an opening clearances between the indoor side and the outdoor side in the duct member 1 generated between the wirings and pipes passed and arranged in the duct member 1 installed at the through-pass holes 31 and 32, to shut off between the indoor side and the outdoor side, and then a duct inserting work for the air conditioner is finished.

### BRIEF DESCRIPTION OF THE DRAWINGS

FIG. 1(a) is a perspective view showing the through-pass duct member of the present invention being the state where no force is applied.

FIG. 1(b) is a perspective view showing the through-pass duct member of the present invention applied a certain force to be bent.

FIG. 1(c) is a perspective view showing the through-pass duct member of the present invention deformed into a shrink state.

FIG. 2 is a vertical cross sectional side view showing the through-pass duct member in FIG. 1(c).

FIG. 3(a) is a vertical cross sectional perspective view showing the cylinder body side of the end part depressing member.

FIG. 3(b) is a vertical cross sectional perspective view showing the flange part of the end part depressing member.

FIG. 4(a) is a vertical cross sectional perspective view showing the form of the cylinder body with a flange of the end part depressing member.

FIG. 4(b) is a vertical cross sectional perspective view showing the cylinder body side fixing and attaching the flange of the end part depressing member.

FIG. 4(c) is a vertical cross sectional perspective view showing the flange part of the end part depressing member.

FIG. 5(a) is a perspective view showing the ring-like filler member.

FIG. 5(b) is a vertical cross sectional perspective view showing the ring-like filler member.

FIG. 6 is a vertical cross sectional perspective view showing the through-pass hole of the hollow wall structure.

FIG. 7 is a vertical cross sectional perspective view showing the duct structure of the hollow wall fixing the through-pass duct member.

FIG. 8 is a vertical cross sectional perspective view showing the work process in FIG. 7.

FIG. 9 is a vertical cross sectional perspective view showing the work process in FIG. 8.

FIG. 10 is a vertical cross sectional perspective view showing the duct structure of the hollow wall fixing the through-pass duct member.

FIG. 11 is a vertical cross sectional perspective view showing the duct structure of the hollow wall fixing the end part depressing member.

FIG. 12 is a vertical cross sectional perspective view showing another type of the duct structure of the hollow wall fixing the end part depressing member.

FIG. 13 is a vertical cross sectional perspective view showing the duct structure after fixing the air conditioner shut off the both side of through-pass duct member by filler.

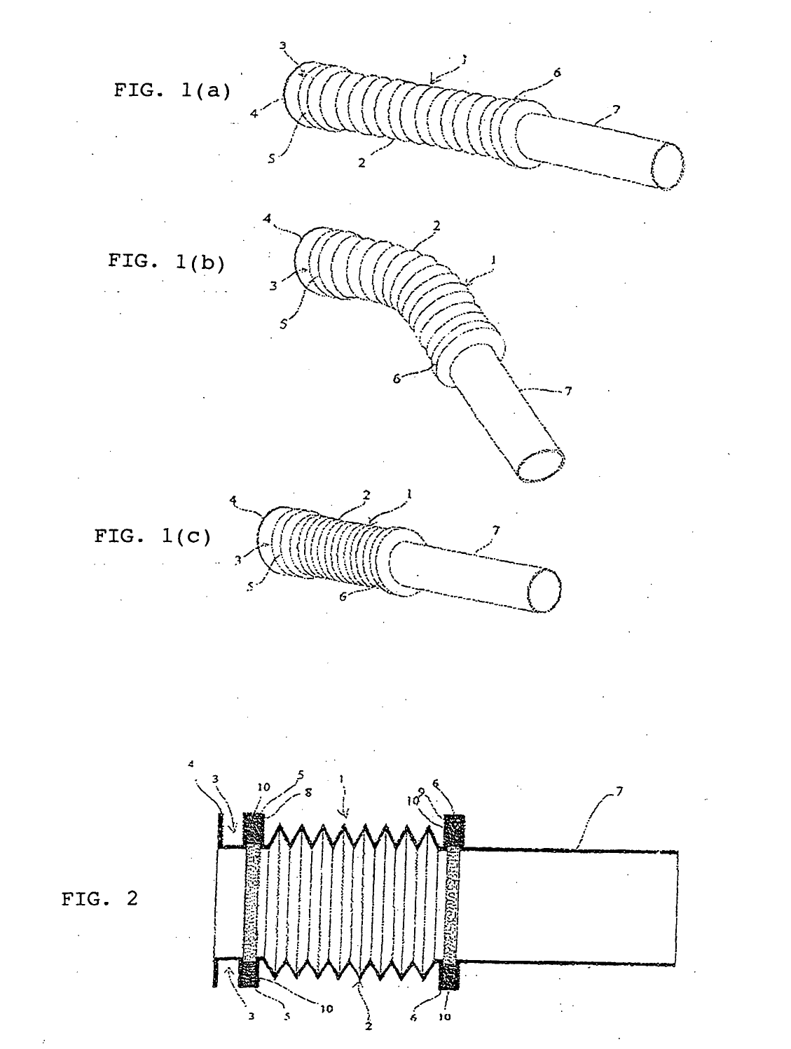

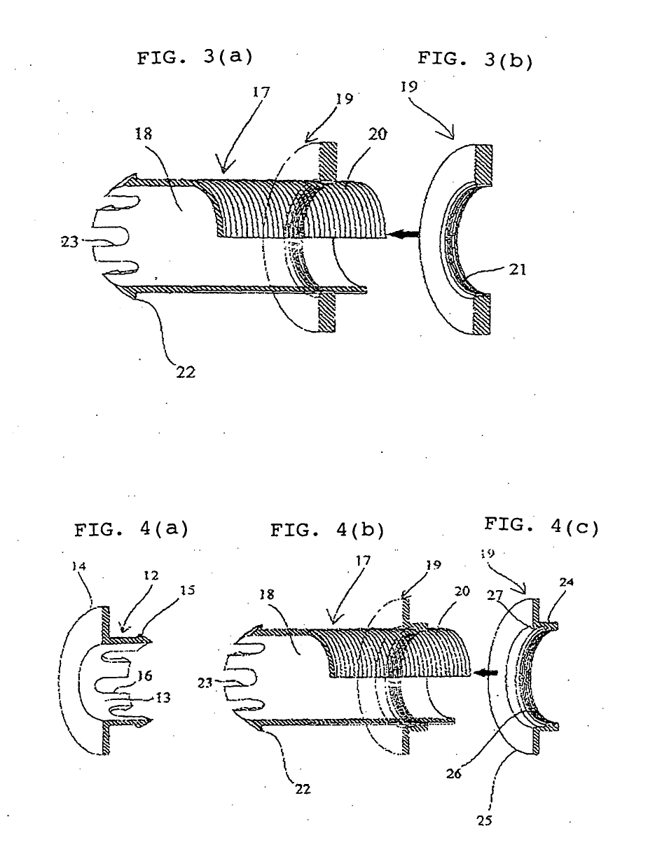

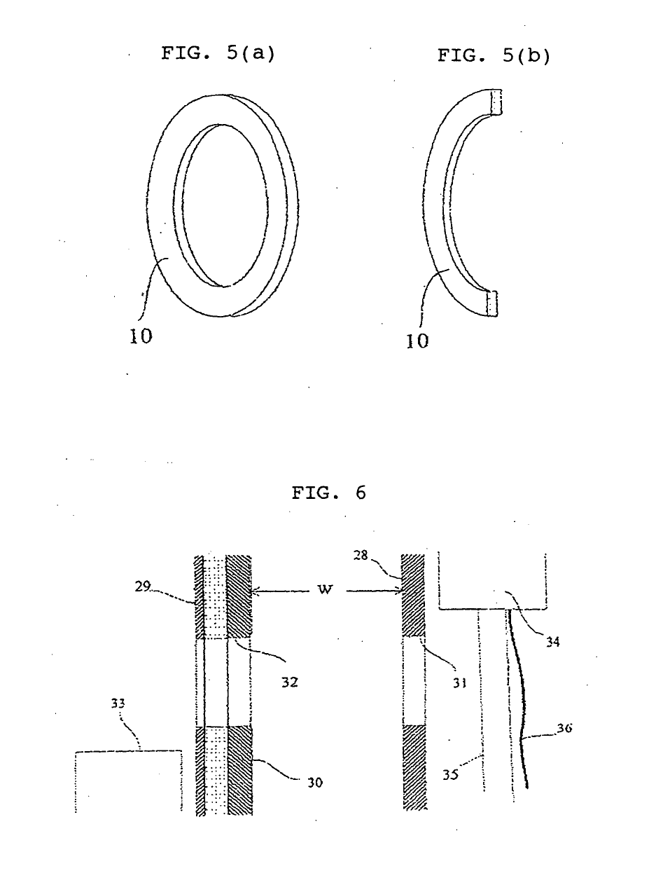

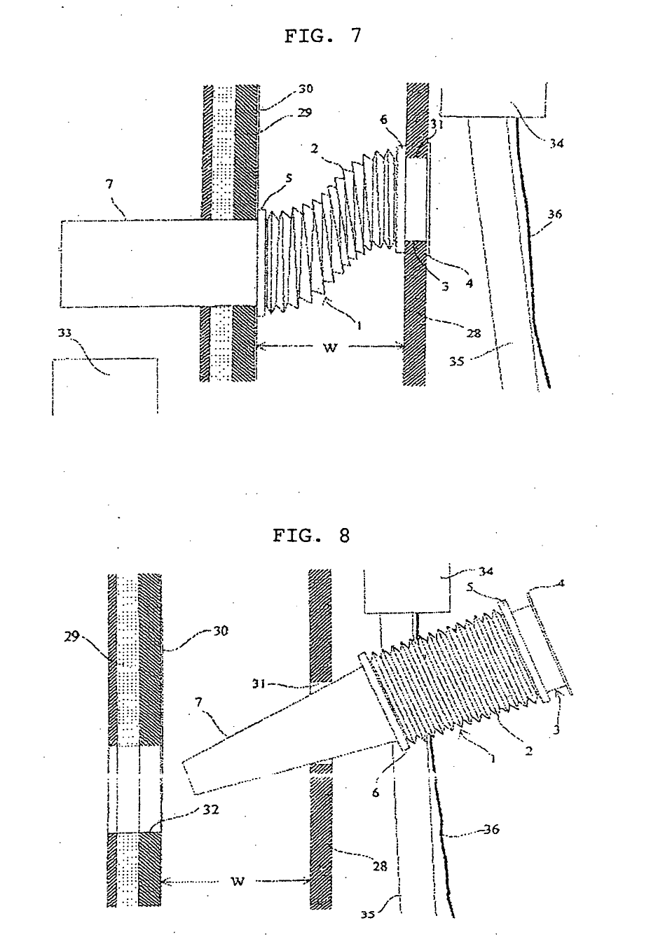

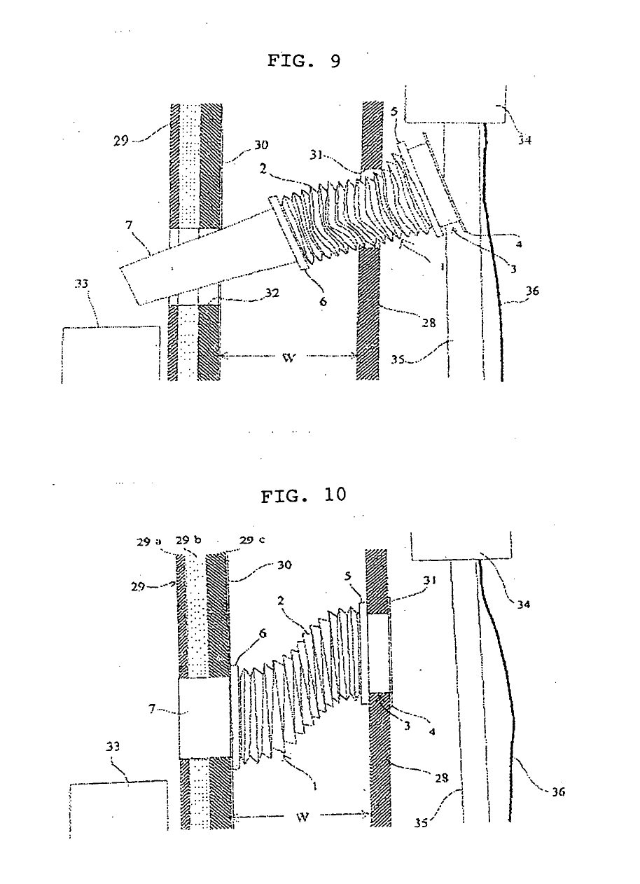

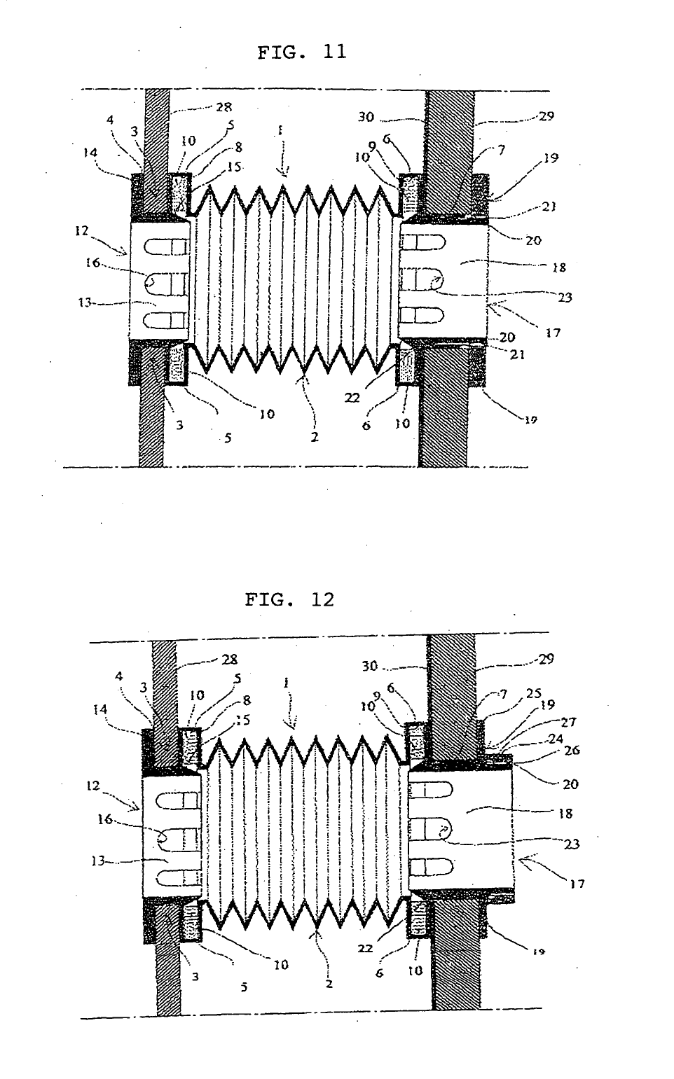

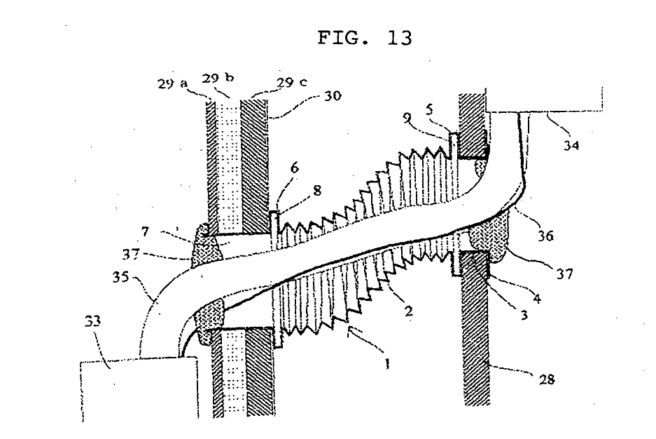

### DESCRIPTION OF REFERENCE NUMERALS

W hollow interval
1 duct member
2 extension or shrinkage part
3 outer peripheral groove
4 outer flange
5 inner flange
6 inner flange
7 insertion guide part
8 inner peripheral groove
9 inner peripheral groove
10 ring-like filler member
12 end part depressing member
13 cylinder body
14 flange part
15 protrusion
16 split groove
17 end part depressing member
18 cylinder body
19 flange member
20 male threaded part
21 female threaded part
22 protrusion
23 split groove
24 cylinder part
25 flange part
26 female threaded part
27 insertion groove
28 inner wall
29 outer wall
29a cement type outer wall
29b foamed resin thermal insulation
29c gypsum board
30 airtightness sheet
37 filler

### INDUSTRIAL APPLICABILITY

This invention relates to the duct structure of the through-pass duct member and the hollow wall using the through-pass duct member. Moreover this through-pass duct member is enable to use to keep airtightness inside of the double-wall structure if the through-pass hole is installed at the portion made the double-wall structure having a interval among of a wall surface, a floor surface, ceiling surface, and etc.

1. A through-pass duct member integrally formed with a duct member made of synthetic resin having flexibility and resilience that can be passed through and fixed to a through-pass hole of a hollow wall comprised of an inner wall and an outer wall, wherein
the outer periphery at one side of said duct member is formed with an outer flange having a larger diameter than that of said through-pass hole at the end side and is formed with an inner flange having a larger diameter than that of said through-pass hole to form an outer peripheral groove with a groove width approximately equal to a thickness of either said inner wall or the outer wall at a central side from said outer flange;
the outer periphery at the other side of said duct member is provided with an inner flange having a larger diameter than that of said through-pass hole at a location spaced apart from said inner flange at a longer distance than a hollow interval between the walls and is formed with a longer insertion guide part than said hollow interval at an end side more near than said inner flange;
an outer peripheral diameter of said duct member has an outer diameter approximately equal to that of the through-pass hole in the inner wall or the outer wall at the one side at said outer peripheral groove and has an outer diameter approximately equal to that of the through-pass hole at the other side at a location near the inner flange at said insertion guide part side;
the inner peripheral surfaces of said both inner flanges are formed with the inner peripheral grooves expanding into a thickness of the inner flange respectively;
and
a bellows-like extension or shrinkage part having an inner diameter approximately equal to that of the throughpass hole, having a length longer than an interval between said the outer wall and the inner wall, having a length stored in said interval between said outer wall and the inner wall when shrunk, and having a thickness with deformable flexibility by finger force and restoring force is formed between said inner flanges.

2. The through-pass duct member according to claim 1, wherein a flexible ring-like filler member having a thickness approximately equal to a groove width of said inner peripheral groove and having resilience is filled in the groove of the inner peripheral groove.

3. The through-pass duct member according to claim 2, wherein the ring-like filler member filled in the groove of the inner peripheral groove is fixed in said inner peripheral groove at its one semi-peripheral side and the other semi-peripheral side not fixed is stored in such a way that it can be taken out of said inner peripheral groove.

4. A through-pass duct member provided with an end part depressing member inserted at the end of a duct member of the through-pass duct member according to claim 1 so as to fix the end of the duct member in the through-pass hole in a hollow wall, wherein said end part depressing member is provided with a flange part at the base end of a cylinder body having an outer peripheral diameter approximately equal to the inner peripheral diameter of either one or both ends of said duct member, the extremity end of the cylinder body is formed with, at the outer peripheral surface, protrusions that can be engaged in the inner peripheral groove of said duct member under a state where said flange part is connected with the outer surface of said outer wall or inner wall, and formed with split grooves spaced apart in a peripheral direction of said cylinder body and reaching from the extremity end to the deeper location than that of said protrusions.

5. A through-pass duct member provided with an end part depressing member inserted at the end of a duct member of the through-pass duct member according to claim 1 so as to fix the end of the duct member in the through-pass hole in a hollow wall, wherein said end part depressing member is made such that a base end of a cylinder body having an outer peripheral diameter approximately equal to an inner peripheral diameter of either one or both of ends of said duct member is formed, at the outer peripheral surface, with a male threaded part and is threadably provided with a flange member formed with a female threaded part threadably engaged with said male threaded part, the extremity end of said cylinder body is formed with, at the outer peripheral surface, with protrusions that can be engaged in the inner peripheral groove of said duct member under a state in which said flange part is connected with the outer surface of said outer wall or the inner wall, and formed with split grooves spaced apart in a peripheral direction of said cylinder body and reached from the extremity end up to the deeper location than that having said protrusions.

6. A through-pass duct member, wherein the flange member of the end part depressing member according to claim 5 comprises a cylinder part and a flange part formed at its extremity end, the inner peripheral surface at a base end side of said flange part is formed with a female threaded part threadably engaged with a male threaded part formed at the outer peripheral surface of said end part depressing member, and the inner peripheral surface at the extremity end side of said flange part is formed with an insertion groove enabling an insertion guide part for said duct member to be inserted.

7. A duct structure of a hollow wall in which an airtightness sheet is arranged in tension at least one inner surface of a wall of a hollow wall comprised of an outer wall and an inner wall, and the through-pass duct member according to claim 1 is used in respect to the through-pass holes having diameters approximately equal to each other passing through each of these materials, wherein said through-pass duct member is inserted into the through-pass hole arranged in the outer wall or the inner wall from one of them with an insertion guide part being applied as a leading one; an outer peripheral groove in said through-pass duct member is fitted and fixed to the insertion side wall, and at the same time the leading inner flange is left in the hollow space of the wall and, said insertion guide part is protruded out of said through-pass hole outwardly; said both inner flanges depress against the hollow inner wall surfaces of the outer wall and the inner wall with a recovering force of the bellows-like extension or shrinkage part between both inner flanges of said throughpass duct member to shut off between both through-pass holes and the outer periphery of the duct member; and airtightness of the hollow space between the outer wall and the inner wall can be kept.

8. A duct structure of a hollow wall in which an airtightness sheet is arranged in tension at least one inner surface of a wall of a hollow wall comprised of an outer wall and an inner wall, and the through-pass duct member according to claim 4 used in respect to the through-pass holes having diameters approximately equal to each other passing through each of these materials, wherein
said through-pass duct member is inserted into the through-pass hole arranged in the outer wall or the inner wall from one of them with an insertion guide part being applied as a leading one;
an outer peripheral groove in said through-pass duct member is fitted and fixed to the insertion side wall, and at the same time the leading inner flange is left in the hollow space of the wall and, said insertion guide part is protruded out of said through-pass hole outwardly;
said both inner flanges depress against the hollow inner wall surfaces of the outer wall and the inner wall with a recovering force of the bellows-like extension or shrinkage part between both inner flanges of said throughpass duct member to shut off between both through-pass holes and the outer periphery of the duct member;
the end part depressing member inserted from the outer flange formed at one side of said through-pass duct member into the duct, and the end of the duct member is fixed to said through-pass hole; and airtightness of the hollow space between the outer wall and the inner wall can be kept.

9. A duct structure of the hollow wall using the throughpass duct member according to claim 7, wherein an insertion guide part protruded out of the throughpass hole at an insertion guide part side outwardly is cut;
protrusions of the end part depressing member are inserted from the cut and removed insertion guide part side into an inner peripheral groove at the inner peripheral surface of the duct member and engaged with it;
a flange part threadbare engaged with a cylinder body of said end part depressing member is rotated and forcedly abutted against an outer surface of the wall;
the wall material is held by the inner flange of the duct member and a flange member of said end part depressing member to fix the end of the insertion guide part side of the duct member to said through-pass hole; and
airtightness of the hollow space between the outer wall and the inner wall at the both sides of the duct member can be kept.

10. A duct structure of a hollow wall according to claim 7, wherein a filler is filled in an opening clearance at the indoor side and the outdoor side in the duct member generated between the wirings and pipes passed and arranged in the duct member installed at the throughpass hole, to shut off between the indoor side and the outdoor side.

11. A through-pass duct member provided with an end part depressing member inserted at the end of a duct member of the through-pass duct member according to claim 2 so as to fix the end of the duct member in the through-pass hole in a hollow wall, wherein said end part depressing member is provided with a flange part at the base end of a cylinder body having an outer peripheral diameter approximately equal to the inner peripheral diameter of either one or both ends of said duct member, the extremity end of the cylinder body is formed with, at the outer peripheral surface, protrusions that can be engaged in the inner peripheral groove of said duct member under a state where said flange part is connected with the outer surface of said outer wall or inner wall, and formed with split grooves spaced apart in a peripheral direction of said cylinder body and reaching from the extremity end to the deeper location than that of said protrusions.

12. A through-pass duct member provided with an end part depressing member inserted at the end of a duct member of the through-pass duct member according to claim 3 so as to fix the end of the duct member in the through-pass hole in a hollow wall, wherein said end part depressing member is provided with a flange part at the base end of a cylinder body having an outer peripheral diameter approximately equal to the inner peripheral diameter of either one or both ends of said duct member, the extremity end of the cylinder body is formed with, at the outer peripheral surface, protrusions that can be engaged in the inner peripheral groove of said duct member under a state where said flange part is connected with the outer surface of said outer wall or inner wall, and formed with split grooves spaced apart in a peripheral direction of said cylinder body and reaching from the extremity end to the deeper location than that of said protrusions.

13. A through-pass duct member provided with an end part depressing member inserted at the end of a duct member of the through-pass duct member according to claim 2 so as to fix the end of the duct member in the through-pass hole in a hollow wall, wherein said end part depressing member is made such that a base end of a cylinder body having an outer peripheral diameter approximately equal to an inner peripheral diameter of either one or both of ends of said duct member is formed, at the outer peripheral surface, with a male threaded part and is threadably provided with a flange member formed with a female threaded part threadably engaged with said male threaded part, the extremity end of said cylinder body is formed with, at the outer peripheral surface, with protrusions that can be engaged in the inner peripheral groove of said duct member under a state in which said flange part is connected with the outer surface of said outer wall or the inner wall, and formed with split grooves spaced apart in a peripheral direction of said cylinder body and reached from the extremity end up to the deeper location than that having said protrusions.

14. A through-pass duct member provided with an end part depressing member inserted at the end of a duct member of the through-pass duct member according to claim 3 so as to fix the end of the duct member in the through-pass hole in a hollow wall, wherein said end part depressing member is made such that a base end of a cylinder body having an outer peripheral diameter approximately equal to an inner peripheral diameter of either one or both of ends of said duct member is formed, at the outer peripheral surface, with a male threaded part and is threadably provided with a flange member formed with a female threaded part threadably engaged with said male threaded part, the extremity end of said cylinder body is formed with, at the outer peripheral surface, with protrusions that can be engaged in the inner peripheral groove of said duct member under a state in which said flange part is connected with the outer surface of said outer wall or the inner wall, and formed with split grooves spaced apart in a peripheral direction of said cylinder body and reached from the extremity end up to the deeper location than that having said protrusions.

15. A duct structure of a hollow wall in which an airtightness sheet is arranged in tension at least one inner surface of a wall of a hollow wall comprised of an outer wall and an inner wall, and the through-pass duct member according to claim 2 is used in respect to the through-pass holes having diameters approximately equal to each other passing through each of these materials, wherein said through-pass duct member is inserted into the through-pass hole arranged in the outer wall or the inner wall from one of them with an insertion guide part being applied as a leading one; an outer peripheral groove in said through-pass duct member is fitted and fixed to the insertion side wall, and at the same time the leading inner flange is left in the hollow space of the wall and, said insertion guide part is protruded out of said through-pass hole outwardly; said both inner flanges depress against the hollow inner wall surfaces of the outer wall and the inner wall with a recovering force of the bellows-like extension or shrinkage part between both inner flanges of said throughpass duct member to shut off between both through-pass holes and the outer periphery of the duct member; and airtightness of the hollow space between the outer wall and the inner wall can be kept.

16. A duct structure of a hollow wall in which an airtightness sheet is arranged in tension at least one inner surface of a wall of a hollow wall comprised of an outer wall and an inner wall, and the through-pass duct member according claim 3 is used in respect to the through-pass holes having diameters approximately equal to each other passing through each of these materials, wherein said through-pass duct member is inserted into the through-pass hole arranged in the outer wall or the inner wall from one of them with an insertion guide part being applied as a leading one; an outer peripheral groove in said through-pass duct member is fitted and fixed to the insertion side wall, and at the same time the leading inner flange is left in the hollow space of the wall and, said insertion guide part is protruded out of said through-pass hole outwardly; said both inner flanges depress against the hollow inner wall surfaces of the outer wall and the inner wall with a recovering force of the bellows-like extension or shrinkage part between both inner flanges of said throughpass duct member to shut off between both through-pass holes and the outer periphery of the duct member; and airtightness of the hollow space between the outer wall and the inner wall can be kept.

17. A duct structure of a hollow wall in which an airtightness sheet is arranged in tension at least one inner surface of a wall of a hollow wall comprised of an outer wall and an inner wall, and the through-pass duct member according to claim 5 is used in respect to the through-pass holes having diameters approximately equal to each other passing through each of these materials, wherein
said through-pass duct member is inserted into the through-pass hole arranged in the outer wall or the inner wall from one of them with an insertion guide part being applied as a leading one;
an outer peripheral groove in said through-pass duct member is fitted and fixed to the insertion side wall, and at the same time the leading inner flange is left in the hollow space of the wall and, said insertion guide part is protruded out of said through-pass hole outwardly;
said both inner flanges depress against the hollow inner wall surfaces of the outer wall and the inner wall with a recovering force of the bellows-like extension or shrinkage part between both inner flanges of said throughpass duct member to shut off between both through-pass holes and the outer periphery of the duct member;
the end part depressing member is inserted from the outer flange formed at one side of said through-pass duct member into the duct, and the end of the duct member is fixed to said through-pass hole; and airtightness of the hollow space between the outer wall and the inner wall can be kept.

18. A duct structure of a hollow wall in which an airtightness sheet is arranged in tension at least one inner surface of a wall of a hollow wall comprised of an outer wall and an inner wall, and the through-pass duct member according to claim 6 used in respect to the through-pass holes having diameters approximately equal to each other passing through each of these materials, wherein
said through-pass duct member is inserted into the through-pass hole arranged in the outer wall or the inner wall from one of them with an insertion guide part being applied as a leading one;
an outer peripheral groove in said through-pass duct member is fitted and fixed to the insertion side wall, and at the same time the leading inner flange is left in the hollow space of the wall and, said insertion guide part is protruded out of said through-pass hole outwardly;
said both inner flanges depress against the hollow inner wall surfaces of the outer wall and the inner wall with a recovering force of the bellows-like extension or shrinkage part between both inner flanges of said throughpass duct member to shut off between both through-pass holes and the outer periphery of the duct member;
the end part depressing member inserted from the outer flange formed at one side of said through-pass duct member into the duct, and the end of the duct member is fixed to said through-pass hole; and airtightness of the hollow space between the outer wall and the inner wall can be kept.

19. A duct structure of the hollow wall using the throughpass duct member according to claim 8, wherein an insertion guide part protruded out of the throughpass hole at an insertion guide part side outwardly is cut;
protrusions of the end part depressing member are inserted from the cut and removed insertion guide part side into an inner peripheral groove at the inner peripheral surface of the duct member and engaged with it;
a flange part threadbare engaged with a cylinder body of said end part depressing member is rotated and forcedly abutted against an outer surface of the wall;
the wall material is held by the inner flange of the duct member and a flange member of said end part depressing member to fix the end of the insertion guide part side of the duct member to said through-pass hole; and
airtightness of the hollow space between the outer wall and the inner wall at the both sides of the duct member can be kept.

20. A duct structure of a hollow wall according to claim 8, wherein a filler is filled in an opening clearance at the indoor side and the outdoor side in the duct member generated between the wirings and pipes passed and arranged in the duct member installed at the throughpass hole, to shut off between the indoor side and the outdoor side.

21. A duct structure of a hollow wall according to claim 9, wherein a filler is filled in an opening clearance at the indoor side and the outdoor side in the duct member generated between the wirings and pipes passed and arranged in the duct member installed at the throughpass hole, to shut off between the indoor side and the outdoor side.
